(19) United States
(12) Patent Application Publication
(10) Pub. No.: US 2008/0060254 A1
(43) Pub. Date: Mar. 13, 2008

(54) Self Baiting Fishing Rig and Method of Fishing

(76) Inventor: Mark C. Bloomfield, Ponte Vedra, FL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/560,404

(22) Filed: Nov. 16, 2006

Related U.S. Application Data
(60) Provisional application No. 60/825,176, filed on Sep. 11, 2006.

(51) Int. Cl. A01K 91/04; A01K 91/00

(52) U.S. Cl. 43/44.84; 43/42.74; 43/43.15; 43/44.83

(57) ABSTRACT

A fishing rig and method of fishing. The fishing rig has a leader with a first and second end, at least one bait hook attached to the leader, and at least one game fish hook attached to the leader. The at least one game fish hook is positioned relative to the at least one bait hook so that a bait attached to the bait hook attracts a game fish to the game fish hook.

### CROSS-REFERENCE TO RELATED APPLICATIONS

This application claims the benefit of U.S. Provisional Application No. 60/825,176, filed on Sep. 11, 2006, the entire contents of which are hereby incorporated by reference as if presented herein in their entirety.

### BACKGROUND OF THE INVENTION

This invention relates generally to the sport of fishing, and more particularly to an improved fishing rig and method of fishing.

Prior art teachings related to methods of fishing typically involve the step of baiting a hook of a fishing rig with either live, or artificial bait. The bait serves as the attractant necessary to entice a game fish to strike the rig such that the fish is hooked in a manner so that it is caught by an angler. There are numerous types of bait, both natural and artificial, that are used by fisherman to catch fish. Typically, the bait is first attached to a fishing rig or hook by the fisherman prior to the presentation of the rig in the water to the game fish. The fishing rig of the present invention is capable of “self-baiting” such that the fishing rig may be initially cast into the water without a game fish bait attached thereto and a live bait becomes caught on the rig for use as an attractant to game fish. The present invention presents the caught bait in an attractive manner to the game fish to cause the game fish to strike the baited rig and become caught on the fishing rig.

One exemplary multi-hook bait rig, commonly known as a Sabiki, is well known in the art and is very popular with fisherman. Sabikis (a Japanese word meaning multi-hook) are multi-hook bait rigs configured for catching bait fish. Sabikis typically consist of a main leader line of lightweight material (e.g., typically 10-17 pound test line) containing multiple branches each having a small, bait fish hook with an artificial lure or fly attached thereto. A weight is attached to one end of the leader line and the other end of the line is typically attached to a lightweight casting rod primarily used for catching bait fish. Bait rigs such as Sabikis are designed to catch small bait fish primarily used as bait for game fishing. Sabiki rigs are typically fished using a jigging method such that the line is dropped into a school of bait fish and jigged up and down to attract the bait fish to the artificially baited hooks. Typically, multiple bait fish are caught on a single drop. The bait fish are then removed from the hooks and put into a live well, or otherwise stored until later use as bait for game fishing. Many game fish are attracted only to live fish and therefore keeping the captured bait fish alive and healthy prior to use as bait is important in successfully catching game fish.

Sabiki rigs are used by anglers for catching virtually any species of bait fish used for game fishing. However the use of Sabiki rigs requires a complex and time-consuming fishing method that typically requires catching the bait fish on the Sabiki rig, removing the bait fish from the Sabiki rig, baiting a separate game fish rig with the bait fish, and casting the game fish rig with a game fish casting rod to present the bait fish in a manner that attracts and catches game fish.

Another problem associated with the use of Sabiki rigs is their propensity to tangle both on themselves and other objects. This is mostly attributable to the light weight main leader line that is used for supporting the small bait fish hooks. The leader line is typically 5′-6′ in length and readily tangles when removed from the casting rod. This problem is so pronounced that U.S. Pat. No. 7,043,872 was issued to an inventor for an invention whose sole purpose is to maintain Sabiki lines untangled when stored. Another problem with the use of Sabiki rigs is the resultant damage to the small bait fish hooks and/or artificial lures that frequently become damaged and unusable due to the harsh salt environment or due to bites by the bait fish that damage the fly or other artificial lure. Still further, the lightweight main leader line of a Sabiki rig is frequently broken due to snags or tangles with objects that cut the line.

Another existing method for catching bait fish is by use of a cast net. Many anglers prefer to catch bait by this method rather than fishing for baits with Sabiki rigs. More fish can be caught with a single cast of a cast net and the fish are not as likely to be compromised or damaged as when they are a hooked with a Sabiki rig. If fishing from a shore or bank, bait casting with a cast net can be a challenge to many anglers as bait fish often swim too far offshore to be reached by a cast net, or the bait fish are easily spooked by an approaching caster and swim quickly out of harms way. Also, bait fish frequently spook and dive to deeper water upon being approached by boats prior to the cast net closing around them. Often an angler is unsuccessful in catching bait fish in a bait fish populated area due to the aforementioned problems as well as other typical problems.

Because game fish present a different set of catching problems than bait fish, a game fish rig must be configured in a different manner to have different components (e.g., size and number of hooks, weight of line, etc.) than a bait fish rig. Game fish rig configurations are determined by the typical characteristics of the game fish (e.g., weight, fighting tenacity, length of fight, mouth structure, etc.). Additionally, the method of presentation of the bait, either natural or artificial, is often vital to attract and catch a game fish. All of these characteristics make a game fish rig different from a bait fish rig. Typically, game fish rigs have a heavier weight line material and larger hooks for catching the typically heavier game fish that are larger and more difficult to catch than bait fish. Bait fish rigs are typically considered to be light tackle and game fish rigs are typically considered to be mid-to-very-heavy tackle. Therefore, anglers typically will have a least two sets of equipment (e.g., tackle, casting rod, etc.) for fishing, one set of equipment for catching bait fish and another set of equipment for catching game fish.

Another problem for fishermen is the ability to cast game fish rigs with distance and with accuracy when baited with live bait fish. In windy conditions, game fish rigs baited with lighter bait fish can sail off target, or if cast into the wind, will fall short of the target. Game fish rigs baited with heavier live bait are typically cumbersome to cast due to the increased weight of the rig. Furthermore, many species of bait fish have soft mouth or body structures and frequently become damaged, killed, or stunned upon impact with the water when cast a long distance on a game fish rig. Damaged or dead bait fish on a game fish rig are not an attractive presentation to a game fish, resulting in less game fish caught by the fisherman.

Accordingly, a need exists for an improved fishing rig and method of fishing alleviating, at least in part, the above-stated deficiencies and other deficiencies.

### SUMMARY OF THE INVENTION

In general, one aspect of the invention is generally directed to a fishing rig generally comprising a leader having a first end and a second end. At least one bait hook is attached to the leader for catching bait and at least one game fish hook is attached to the leader for catching game fish.

In another aspect, the invention is generally directed to a method of fishing. The method generally comprising providing a fishing rig comprising a leader, at least one bait hook attached to the leader, and at least one game fish hook attached to the leader. The fishing rig is attached to a fishing line and positioned at an expected location of bait so that at least one bait is attracted to the at least one bait hook. The fishing rig is positioned at an expected location of game fish so that a game fish striking the at least one bait is caught on the at least one game fish hook.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the invention.

### BRIEF DESCRIPTION OF THE DRAWINGS

FIG. 1 illustrates a fishing rig of one embodiment of the present invention.

FIG. 2 is an enlarged view of a portion of a fishing rig according to the embodiment of FIG. 1, showing a bait fish line partially removed.

FIG. 3 is an enlarged portion of FIG. 2.

Corresponding parts are designated by corresponding reference numbers throughout the drawings.

### DETAILED DESCRIPTION OF THE EXEMPLARY EMBODIMENTS

The present invention is directed to a fishing rig, generally indicated at 1, for use in catching game fish. The fishing rig 1 is designed and constructed to attract and catch live bait (not shown) that is used to attract larger game fish (not shown) that are caught with the fishing rig. The bait typically includes smaller fish (e.g., alewives, anchovies, ballyhoos, blue runners, butterfish, croakers, flying fish, herring, menhaden, pilchards, pinfish, sardines, smelt, bonito, mackerel, grunts, whiting, or any other fish or organism used to attract game fish) that are a source of food for typically larger game fish (e.g., amberjack, dolphin, grouper, jacks, kingfish, marlin, redfish, sailfish, sea trout, snook, tarpon, tuna and wahoo, bonito, cobia, ladyfish, snapper, barracuda, or any other game fish). The fishing rig 1 is suitable for use in freshwater or saltwater fishing environments and can accommodate bait and game fish of any type, size, and environment.

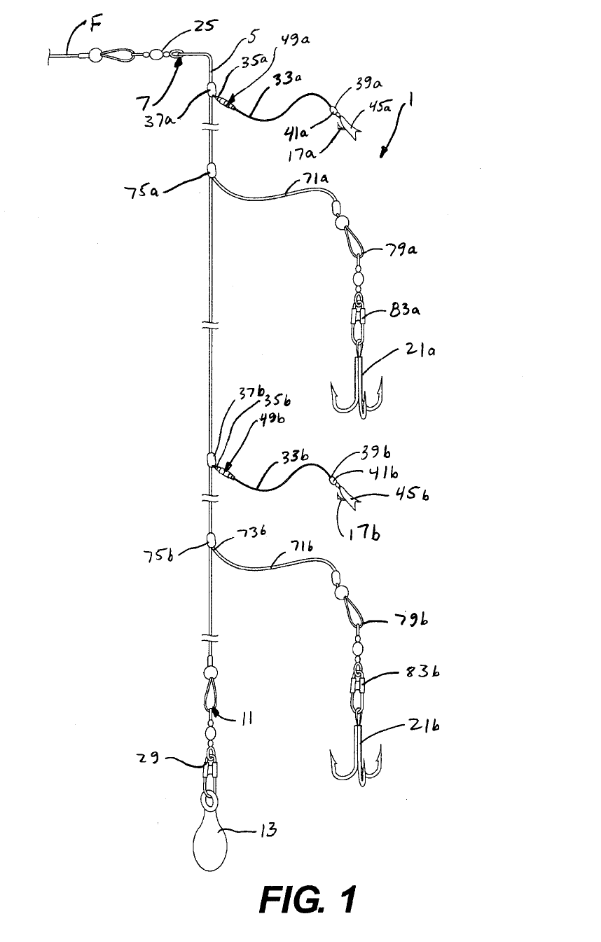

As shown in FIG. 1, the fishing rig 1 comprises a leader 5 having a first end 7 attached to a fishing line F and a second end 11 attached to a weight 13. In the illustrated embodiment, the weight 13 is connected to the second end 11 of the leader 5 to aid in casting and jigging the fishing rig 1. Alternatively, the weight 13 may be omitted from the fishing rig 1, the weight may be replaced with a game fish hook (not shown), or the rig may be attached to another fishing rig (not shown) at the second end 11. It is understood that although a single fishing rig 1 is shown attached to the fishing line F, multiple fishing rigs may be interconnected to increase the effective length of the fishing rig.

At least one bait hook 17 (see for example, 17a, 17b) is attached to the leader 5 for catching bait such as bait fish. At least one game fish hook 21 (see for example, 21a, 21b) is attached to the leader for catching a game fish. In the illustrated embodiment, two bait hooks 17a, 17b are respectively attached to the leader by a first and a second bait line 33a, 33b and two game fish hooks 21a, 21b are respectively attached to the leader by a first and a second game fish line 71a, 71b. But, less than or more than two bait hooks 17a, 17b and/or less than or more than two game fish hooks 21a, 21b could be used without departing from the scope of this invention. As shown in FIGS. 1-3, the two bait lines 33a, 33b and the two game fish lines 71a, 71b each include identical components so that the corresponding elements respectively associated with the first bait line 33a and the first game fish line 71a are identified by the suffix “a” after the corresponding reference numbers. Similarly, the corresponding elements respectively associated with the second bait line 33b and the second game fish line 71b are identified by the suffix “b” after the corresponding reference numbers. Unless referring to a specific element associated with a specific bait line 33a, 33b or game fish line 71a, 71b, the suffix may sometimes be omitted to indicated the elements generic representation or for ease of notation. Alternatively, the first and/or second bait lines 33a, 33b may have different components and the first and/or second game fish lines 71a, 71b may have different components without departing from the scope of this invention. Further, one or more of the bait hooks 17a, 17b may be directly attached to the leader 5 without the use of a bait line 33a, 33b and one or more of the game fish hooks 21a, 21b may be directly attached to the leader without the use of a game fish line 71a, 71b.

The leader 5 has a barrel swivel 25 at its first end 7 for connection to the fishing line F and a releasable connector (e.g., snap swivel 29) at its second end 11. The barrel swivel 25 and snap swivel 29 are both #1/0 size swivels that are available from Jeros Tackle of Rahway, N.J. Other sizes and type (e.g., releasable, non-releasable, etc.) of connectors could be used without departing from the scope of this invention. In the illustrated embodiment, the leader 5 is of sufficient length to accommodate spacing of the bait hooks 17 and the game fish hooks 21. The leader 5 can be constructed of various materials having various weights and strengths (e.g., monofilament, fluorocarbon, wire, metal, braided, etc.). In one embodiment the leader is constructed of 80 pound test fluorocarbon leader material manufactured by Pure Fishing Inc. of Spirit Lake, Iowa. The type, weight and construction of the leader 5 is selected upon consideration of the species of game fish to be caught. In the illustrated embodiment, the snap swivel 29 at the second end 11 of the leader 5 connects the weight 13 to the leader. Alternatively, a game fish hook, of similar or different construction than game fish hook 21, can be connected to the snap swivel 29 at the second end 11 of the leader 5 without departing from this invention.

In the illustrated embodiment, each bait line 33 has a first end 35 attached to the leader 5 by a line crimp 37 and a second end 39 attached to the bait hook 17 by a knot 41 or other suitable attachment means. In the illustrated embodiment, an artificial lure 45 (e.g., fly) is attached to each bait hook 17 for attracting bait to the fishing rig 1. The bait hook 17 and lure 45 may be various shapes and sizes. For example, the bait hook 17 and lure 45 may be any of the Sabiki-type hooks and lures commercially available Hayabusa U.S.A., Inc. of Chino Hills, Calif., or any other suitable hook and lure combination suitable for catching live bait.

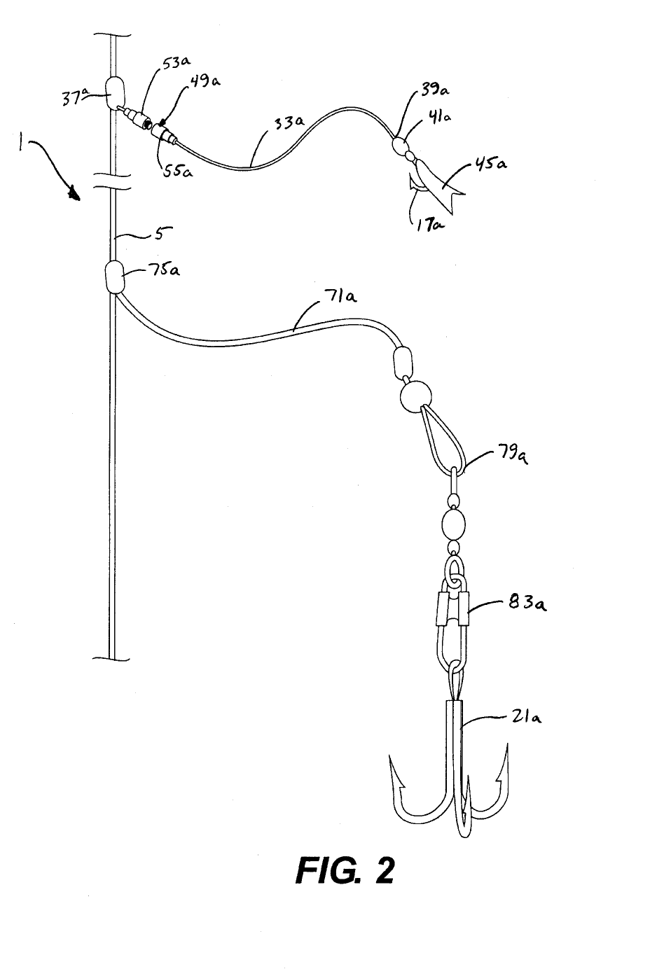

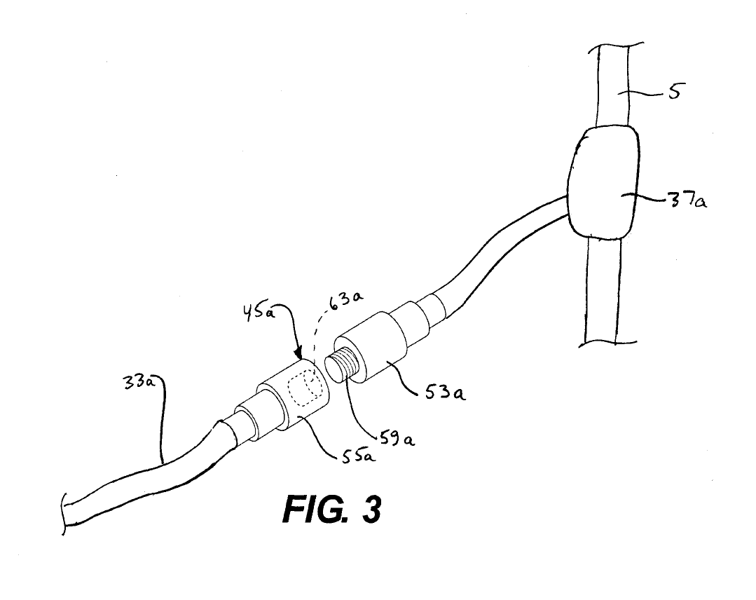

As shown in FIGS. 1-3, each bait line 33 includes a releasable connector 49 for removable attachment of the bait hook 17 to the fishing rig 1. The releasable connector 49 allows the size and type of bait hook 17 and lure 45 to be quickly and easily changed based on the type of bait to be attracted to the fishing rig 1. As shown in FIGS. 2 and 3, each bait line 33 includes a male connector 53 attached to the leader line 5 via the line crimp 37 and a female connector 55 attached to the bait hook 17 and artificial lure 45. The male connector 53 and female connector 55 of the releasable connector are sized and shaped for mating engagement to secure the bait hook 17 to the leader 5. As shown in FIG. 3, the male connector 53 includes a threaded, cylindrical portion 59 sized and shaped for mating engagement with the female connector 55. The female connector 55 has a threaded recess 63 shaped for releasable engagement with the cylindrical portion 59 of the male connector 55. The releasable connector 49 may be otherwise shaped and arranged without departing from the scope of this invention. For example, the releasable connector 49 may include other types of connections (e.g., bayonet-type, snap-fit, etc.) without departing from the scope of this invention. Further, the bait line 33 may be releasably or non-releasably attached to the leader 5 with other releasable or non-releasable connectors (e.g., barrel swivel, snap swivel, line crimp, knot, etc.) without departing from the scope of this invention.

In the illustrated embodiment, each game fish line 71 has a first end 73 connected to the leader 5 by a line crimp 75 and a second end 79 releasably attached to the game fish hook 21 by a snap swivel 83. The snap swivel 83 allows each game fish hook 21 on the fishing rig 1 to be interchanged with various other sizes and types of game fish hook so that the fishing rig can be adapted to various fishing environments. Suitable game fish hooks 21 include Model L774G Size 3/0 treble hooks manufactured by Eagle Claw Fishing Tackle Co. of Denver, Colo., but other suitable types and sizes of hooks (e.g., circle offset hooks, triple barbed circle hooks, etc.) could be used without departing from the scope of this invention. In the illustrated embodiment, each game fish line 71 comprises a single game fish hook 21, but it is understood that one or more of the game fish lines may comprise multiple game fish hooks without departing from the scope of this invention. Also, less than or more than two game fish lines 71 could be attached to the leader 5 and one or more of the game fish hooks 21 could be directly attached to the leader without the use of a game fish line.

In one embodiment, the leader 5 of the fishing rig 1 has an overall length between the first and second ends 7, 11 ranging from approximately 24 inches to approximately 40 inches. The length from the swivel connector 25 at the first end 7 of the leader 5 to the line crimp 37a connecting the first bait line 33a to the leader 5 is in the range of approximately six to eight inches. The spacing from the line crimp 37a connecting the first bait line 33a to the leader 5 to the line crimp 75a connecting the first game fish line 71a to the leader is in the range of approximately six to ten inches. The second bait line 33b and second game fish line 71b may be similarly spaced. Also, the first and second bait lines 33a, 33b may each have a length between respective first and second ends 35, 39 ranging from approximately six to eight inches. The first and second game fish lines 71a, 71b may have a length between respective first and second ends 73, 79 ranging from approximately six to eight inches. The dimensions presented herein are exemplary of one embodiment of the invention and are not intended to limit the scope of the invention. It is understood that the fishing rig 1 may have other dimensions without departing from the invention.

In one preferred embodiment, the leader 5 and the game fish lines 71 comprise a thicker, stronger, and more durable material than the bait lines 33. The material for the game fish lines 71 and the leader 5 may be any suitable material for catching game fish. In one embodiment, the leader 5 and game fish lines 71 each comprise an 80 pound test fluorocarbon material, such as is commercially available from Pure Fishing Inc. of Spirit Lake, Iowa. In other embodiments, the materials and/or strength ratings of the leader 5 and the game fish lines 71 may vary. For example, the leader 5 may comprise wire material and the game fish lines 71 may comprise monofilament. The materials and strength ratings described herein are exemplary only and are intended to be illustrative and not to limit the scope of the invention.

In one preferred embodiment, the bait lines 33 each comprise a lighter, weaker, less durable material than the game fish lines 71 and the leader 5. In one embodiment, the bait lines 33 comprise a 10 pound test monofilament nylon material, such as is commercially available from Berkley Fishing of Spirit Lake, Iowa. The bait line 33 could comprise any material having a sufficient strength rating that is suitable for catching bait fish.

In use, the fishing rig 1 is attached to a fishing line F that may be connected to a casting rod (not shown). The casting rod is used to cast the fishing rig 1 into an expected location of bait (i.e., bait fish pod) so that the bait is attracted to the bait hooks 17 by the lures 45. The bait attracted to the fishing rig 1 strikes the bait hooks 17 and becomes hooked on at least one of the bait hooks. The first bait line 33a and first game fish line 71a are positioned on the leader 5 so that caught bait on the first bait hook 17a is positioned in close proximity to the first game fish hook 21a. Similarly, the second bait line 33b and second game fish line 71b are positioned on the leader 5 so that caught bait on the second bait hook 17b is positioned in close proximity to the second game fish hook 21b.

After at least some bait (e.g., at least one bait fish) is hooked on the fishing rig 1, the fishing rig is positioned at an expected location of game fish so that the hooked bait attracts game fish to the game fish hooks 21. When a game fish strikes the hooked bait on the fishing rig 1, the game fish becomes hooked on the game fish hook 21 that is positioned in close proximity to the hooked bait. For example, a game fish that strikes the bait hooked on the first bait hook 17a will likely be hooked by the first game fish hook 21a thereby becoming attached to the fishing rig 1 for capture by the user. Similarly, a game fish that strikes the bait hooked on the second bait hook 17b will likely be hooked by the second game fish hook 21b thereby becoming attached to the fishing rig 1 for capture by the user. Alternatively, a game fish striking the bait hooked on the first bait hook 17a could become hooked on the game fish hook 21b (and vice versa) depending on the size of the game fish and the spacing between the bait hooks and game fish hooks.

In use, the fishing rig 1 may be effective in catching game fish feeding in a location of live bait (e.g., bait pod) without removing the fishing rig from the bait pod. That is, the fishing rig 1 placed in a bait pod may be effective in hooking game fish on one or more of the game fish hooks 21 after bait is caught on one or more of the bait fish hooks 17 or before bait is caught on one or more of the bait fish hooks. Alternatively, the fishing rig 1 may be moved to an expected location of game fish located away from the bait pod after bait has been hooked on one or more of the bait fish hooks 17. Further, the fishing rig 1 may be attached to a buoy, a floatation device, or other device (e.g., trot line, etc.) that suspends the fishing rig in water without departing from the scope of this invention.

The fishing rig 1 of the present invention allows a user to quickly and easily replace the bait hooks 17 and artificial lures 45 attached thereto, with other sizes and types of bait hooks and lures that may be more successful in a particular fishing environment. The bait hooks 17 and lures 45 can be removed and replaced by releasing the releasable connector 49 and replacing the existing bait hook and lure with alternative bait hook and lure arrangement that may have a different size, shape, color, and/or design. Further, the game fish hooks 21 can be quickly and easily replaced by releasing the connector 83, removing the game fish hook, and connecting a game fish hook having a different size and/or configuration to the game fish line 71. In this way, one or more of the bait hooks 17 and one or more of the game fish hooks 21 may be interchanged to create the desired configuration of the fishing rig 1. Accordingly, the fishing rig 1 of the present invention allows a fisherman to present alternative combinations of bait hooks 17, lures 45, and/or game fish hooks 21 based on the fishing environment that is encountered.

The fishing rig 1 of the present invention may also be used in a manner wherein live or artificial bait is attached to at least one of the bait hooks 17 prior to casting the fishing rig. When used in this manner, the pre-attached bait may be used to attract game fish to the fishing rig 1 instead of, or in addition to, any live bait that is caught by the bait hooks 17.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The foregoing description of the invention illustrates and describes various embodiments of the present invention. As various changes could be made in the above construction without departing from the scope of the invention, it is intended that all matter contained in the above description or shown in the accompanying drawings shall be interpreted as illustrative and not in a limiting sense. Furthermore, the scope of the present invention covers various modifications, combinations, alterations, etc., of the above-described embodiments that are within the scope of the claims. Additionally, the disclosure shows and describes only selected embodiments of the invention, but the invention is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the invention without departing from the scope of the invention.

What is claimed is:

1. A fishing rig comprising:
a leader having a first end and a second end;
at least one bait hook attached to the leader for catching bait; and
at least one game fish hook attached to the leader for catching game fish,

2. The fishing rig of claim 1 wherein the at least one game fish hook is positioned relative to the at least one bait hook so that a bait attached to the bait hook attracts a game fish to the game fish hook.

3. The fishing rig of claim 2 further comprising at least one bait line for attaching the at least one bait hook to the leader.

4. The fishing rig of claim 3 further comprising at least one game fish line for attaching the at least one game fish hook to leader.

5. The fishing rig of claim 4 wherein the at least one bait line comprises a first material and the at least one game fish line comprises a second material.

6. The fishing rig of claim 5 wherein the first material is a lightweight material for catching bait fish and the second material is a durable material for catching game fish.

7. The fishing rig of claim 6 wherein the first material has a tensile strength test rating of approximately 10 pounds and the second material has a tensile strength test rating of at least approximately 80 pounds.

8. The fishing rig of claim 6 wherein the leader comprises a third material, the third material being a durable material for catching game fish.

9. The fishing rig of 8 wherein the third material has a tensile strength test rating of at least approximately 80 pounds.

10. The fishing rig of claim 8 wherein the first material comprises a monofilament material and the second and third materials comprise a fluorocarbon material.

11. The fishing rig of claim 3 further comprising an artificial lure attached to the at least one bait hook for attracting bait.

12. The fishing rig of claim 11 wherein the at least one bait hook is removably attached to the rig for replacement of the bait hook.

13. The fishing rig of claim 12 further comprising a connector for releasable attachment of the at least one bait line, the connector comprising a first portion attached to the leader and a second portion attached to the bait line, the first and second portions being capable of releasable engagement.

14. The fishing rig of claim 4 wherein the at least one bait hook comprises two bait hooks,
the at least one bait line comprises a first and a second bait line each respectively attaching one of the two bait hooks to the leader,
the at least one game fish hook comprises two game fish hooks, and
the at least one game fish line comprises a first and a second game fish line each respectively attaching one of the two game fish hooks to the leader

15. The fishing rig of claim 14 wherein the first bait line and first game fish line are respectively attached to the leader at spaced apart locations so that a game fish striking a bait caught on the first bait line is caught by the game fish hook on the first game fish line.

16. The fishing rig of claim 15 wherein the second bait line and the second game fish line are respectively attached to the leader at spaced apart locations so that a game fish striking a bait caught on the second bait line is caught by the game fish hook on the second game fish line.

17. A method of fishing comprising:
providing a fishing rig comprising a leader, at least one bait hook attached to the leader, and at least one game fish hook attached to the leader;
attaching the fishing rig to a fishing line;
positioning the fishing rig at an expected location of bait so that at least one bait is attracted to the at least one bait hook; and
positioning the fishing rig at an expected location of game fish so that a game fish striking the at least one bait is caught on the at least one game fish hook.

18. The method of claim 17 further comprising catching the at least one bait on the at least one bait hook.

19. The method of claim 18 wherein positioning the fishing rig at an expected location of game fish comprises moving the fishing rig away from the expected location of bait.

20. The method of claim 17 wherein the at least one bait hook comprises an artificial lure for attracting bait.

21. The method of claim 20 wherein the at least one bait hook is attached to the leader by at least one bait line and the at least one game fish hook is attached to the leader by at least one game fish line.

22. The method of claim 21 wherein the fishing rig comprises a releasable connector for releasable attachment of the bait hook to the leader.

23. The method of claim 22 further comprising releasing the releasable connector and removing the at least one bait hook from the fishing rig.

24. The method of claim 23 wherein the at least one bait hook is a first bait hook and the method further comprises replacing the first bait hook with a second bait hook.
